(19) United States
(12) Patent Application Publication
(10) Pub. No.: US 2026/0370550 A1
(43) Pub. Date: Nov. 19, 2026

(54) NETWORK NODE, USER EQUIPMENT AND METHODS IN A TELECOMMUNICATIONS NETWORK

(71) Applicant: Telefonaktiebolaget LM Ericsson (publ), Stockholm (SE)

(72) Inventors: Paolo DEBENEDETTI, Genoa (IT); Luca BALDINI, Roma (IT); Gaetano PATRIA, Pagani (IT); Davide MASSINO, Genova (IT); Daniele GAITO, Pagani (IT)

(73) Assignee: Telefonaktiebolaget LM Ericsson (publ), Stockholm (SE)

(21) Appl. No.: 19/146,002

(22) PCT Filed: Feb. 7, 2023
(86) PCT No.: PCT/EP2023/052964

§ 371 Date: Jul. 7, 2025

(51) Int. Cl. H04L 41/0833; H04L 9/00; H04L 43/08

(52) U.S. Cl. CPC H04L 41/0833; H04L 9/50; H04L 43/08; H04L 2209/80

(57) ABSTRACT

A method performed by a network node is provided. The method is for handling rating of energy efficiency and sustainability of available resources in a telecommunications network. A network node obtains rating criteria to be used for rating the energy efficiency and sustainability of the available resources. The rating criteria are obtained from a blockchain in which the criteria are stored encrypted associated to the network node. The network node calculates energy rating parameters relating to the energy efficiency and sustainability of said available resources, based on data related to the available resources and according to the obtained rating criteria. The network node stores the calculated energy rating parameters as a smart contract in the blockchain. The blockchain is a shared public energy related blockchain. The blockchain enables the UE to obtain one or more resources among the available resources based on the energy rating parameters for an upcoming communication.

### TECHNICAL FIELD

Embodiments herein relate to a network node, a user equipment and methods therein. In some aspects, they relate to handling a rating of energy efficiency and sustainability of available resources in a telecommunications network.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point, a Base Station (BS) or a radio base station (RBS), which in some networks may also be denoted, for example, a Base Station (BS), a NodeB (NB), eNodeB (eNB), next generation e-NodeB (ng-eNB) or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5GC is core network, NR is radio access network. As a continued network evolution, the new release of 3GPP specifies a 5G network also referred to as 5G New Radio (NR) and 5G Core (5GC).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

Energy Efficiency is becoming a more and more important area for development and engineering of telecom solutions, see e.g. https://www.mckinsey.com/industries/technology-media-and-telecommunications/our-insights/the-case-for-committing-to-greener-telecom-networks, [Ref. 1]. The next deployment of 5G and future 6G infrastructure requires a massive power supply and this has implications from cost and environmental perspective.

Additionally, the recent power source crisis due to political and war instability pushes mobile network operators towards using removable and local resources that are more reliable and possibly cheaper.

For this reason, mobile network operators are urging Hardware (HW) and Software (SW) vendors to implement strategies and algorithms to optimize resource usage and minimize the network power consumption as well as using green power sources where possible.

Energy efficiency and sustainability, such as e.g., green economy and green power sources are becoming more and more a competitive advantage for the mobile network operators also towards their subscribers if they can claim that the mobile network operators have minimal carbon footprint while providing the same services.

Studies on the telco efficiency problems have been done in the past. As an example, see Telecommunication Power System: Energy Saving, Renewable Sources and Environmental Monitoring: https://www.intechopen.com/chapters/9710 [Ref. 2] and also in the last years, see again [Ref. 1]. They have reported that the main energy consumption is in Base Transceiver Stations (BTSs) and that some actions are possible to reduce the energy consumption and consequently also the carbon footprint and the greenhouse gases emission. Investigations are ongoing on how reduce the BTS energy consumption and on how reduce the number of BTSs without reducing the network performances.

### Power Usage Effectiveness (PUE)

As defined in the Power Usage Effectiveness, https://en.wikipedia.org/wiki/Power_usage_effectiveness [Ref. 5] and described in the Measuring energy efficiency of data centers with the PUE https://www.tempco.it/blog/en/7330/measuring-energy-efficiency-of-data-centers-with-the-pue/ [Ref. 4], the PUE is a ratio that describes how efficiently a computer data center uses energy; specifically, how much energy is used by the computing equipment. This is in contrast to cooling and other overhead that supports the equipment.

PUE is the ratio of total amount of energy used by a computer data center facility to the energy delivered to computing equipment. PUE is the inverse of Data Center Infrastructure Efficiency (DCIE). Table 1 depicts the Level of Efficiency in PUE and DCIE from [Ref. 4].

TABLE 1

| PUE | Level of efficiency | DCIE |
|---|---|---|
| 3.0 | Very inefficient | 33% |
| 2.5 | Inefficient | 40% |
| 2.0 | Average | 50% |
| 1.5 | Efficient | 67% |
| 1.2 | Very efficient | 83% |

A Mobile Network Operator (MNO) will need to handle a big quantity of data collected by e.g. Internet of Senses (IoS) and Internet of Things (IoT) devices, as well as the computing power required by Artificial Intelligence (AI) and machine learning (ML) applications running on their premises that will increase hugely. So, the energy consumption of data centers and network resources is becoming more and more a very hot topic literally, as the amount of waste heat produced by servers and Information Technology (IT) equipment's in their operations.

### SUMMARY

As a part of developing embodiments herein a problem was identified by the inventors and will first be discussed.

In an ideal open MNO market, a subscriber UE should be able to select the services from the most efficient radio cell but also the resources of the most efficient operator or the most efficient network slice within its coverage area. It is also important to know how the energy has been produced: green resources or carbon fossil. In accordance with actual international geopolitical situation, also the country of origin of the used energy fonts is particularly interesting.

There are different methods for auditing the network resource usage of a Telecom network, like the PUE, as mentioned above. However, there is no way to authenticate the measurements collected and used by each operator and compare them

To be able to do so, the UE must be able to obtain, at run time, the power efficiency rating of the MNO resources operating within its coverage area and trust that such data are really based on the same criteria to be comparable.

Today operators do not have trusted measurement of energy efficiency if they are willing to apply better commercial pricing conditions to the subscribers, pushing the final user to use more efficient, sustainable, and green resources.

The fact that the network does not expose a trustable value of energy efficiency for the network resources related to nodes, subscribers, devices, connections, etc., does not allow to select resources based on their green energy sources.

An object of embodiments herein is to improve the way of handling resources energy efficiently and sustainably in a telecommunications network.

According to an aspect of embodiments herein, the object is achieved by a method performed by a network node. The method is for handling rating of energy efficiency and sustainability of available resources in a telecommunications network. The network node obtains rating criteria to be used for rating the energy efficiency and sustainability of the available resources. The rating criteria are obtained from a blockchain in which the criteria are stored encrypted associated to the network node. The network node calculates energy rating parameters relating to the energy efficiency and sustainability of said available resources, based on data related to the available resources and according to the obtained rating criteria. The network node stores the calculated energy rating parameters as a smart contract in the blockchain. The blockchain is a shared public energy related blockchain. The blockchain enables a User Equipment, UE, to obtain one or more resources among the available resources based on the energy rating parameters for an upcoming communication in the telecommunications network.

According to an aspect of embodiments herein, the object is achieved by a method performed by a User Equipment, UE. The method is for selecting resources in a telecommunications network. The UE accesses a blockchain. One or more calculated energy rating parameters are stored as one or more smart contracts in the blockchain. The blockchain is a shared public energy related blockchain. The UE retrieves energy rating parameters from the blockchain. The energy rating parameters relate to energy efficiency and sustainability of available resources in the telecommunications network. The UE selects one or more resources among the available resources based on the retrieved energy rating parameters for an upcoming communication in the telecommunications network. The UE then sends a request to a network node managing the selected one or more resources. The request requests to set up a communication over the selected one or more resources.

According to another aspect of embodiments herein, the object is achieved by a network node. The network node is configured to handle rating of energy efficiency and sustainability of available resources in a telecommunications network. The network node is further configured to:
Obtain rating criteria to be used for rating the energy efficiency and sustainability of the available resources, wherein the rating criteria are obtained from a blockchain in which the criteria are stored encrypted associated to the network node,
calculate energy rating parameters relating to the energy efficiency and sustainability of said available resources, based on data related to the available resources and according to the obtained rating criteria, and
store the calculated energy rating parameters as a smart contract in the blockchain, which blockchain is a shared public energy related blockchain. The blockchain is adapted to enable a User equipment, UE, to obtain one or more resources among the available resources based on the energy rating parameters for an upcoming communication in the telecommunications network 100.

According to another aspect of embodiments herein, the object is achieved by a User Equipment, UE. The UE is configured to select resources in a telecommunications network. The UE is further configured to:
Access a blockchain, wherein one or more calculated energy rating parameters are stored as one or more smart contracts in the blockchain, which blockchain is a shared public energy related blockchain,
retrieve from the blockchain, energy rating parameters relating to energy efficiency and sustainability of available resources in the telecommunications network,
select one or more resources among the available resources based on the retrieved energy rating parameters for an upcoming communication in the telecommunications network, and
send to a network node managing the selected one or more resources, a request to set up a communication over the selected one or more resources.

Thanks to the calculated energy rating parameters are stored as a smart contract in the blockchain, the UE is enabled to access the blockchain, retrieve the energy rating parameters and based on them select a resource that provides the best energy efficiency and sustainability among the available resources for an upcoming communication.

This results in an improved way of handling resources energy efficiently and sustainably in a telecommunications network.

### BRIEF DESCRIPTION OF THE DRAWINGS

Examples of embodiments herein are described in more detail with reference to attached drawings in which:

FIG. 1a is a schematic block diagram illustrating embodiments of a telecommunications network.

FIG. 1b is a schematic block diagram illustrating embodiments of a telecommunications network.

FIG. 2a is a flowchart depicting an embodiment of a method in a network node.

FIG. 2b is a flowchart depicting an embodiment of a method in the network node.

FIG. 3 is a flowchart depicting an embodiment of a method in a UE.

FIG. 4 is a schematic block diagram illustrating an example scenario of embodiments herein.

FIG. 5 is a schematic block diagram illustrating an example scenario of embodiments herein.

FIG. 6 is a schematic block diagram illustrating an example scenario of embodiments herein.

FIG. 7 is a schematic block diagram illustrating embodiments of a network node.

FIG. 8 is a schematic block diagram illustrating embodiments of a UE.

FIG. 9 schematically illustrates a telecommunication network connected via an intermediate network to a host computer.

FIG. 10 is a generalized block diagram of a host computer communicating via a base station with a user equipment over a partially wireless connection.

FIGS. 11-14 are flowcharts illustrating methods implemented in a communication system including a host computer, a base station, and a user equipment.

### DETAILED DESCRIPTION

Examples of embodiments herein relate to telecommunications energy efficiency, e.g. an Agent, for 3GPP Mobile Networks. Examples of embodiments herein are e.g., further related to technical areas such as blockchain, machine learning, artificial Intelligence, 5G, 6G, IoT, and IoS.

Embodiments herein e.g., provide a reliable and trusted telecommunications energy efficiency method, e.g., an authentication method. The method may be based on the distributed ledger technology. In some embodiments of this method, operators are enabled to certify the energy efficiency of their network resources, publishing their certified energy rating parameters for each coverage area and for each service type.

Such energy rating parameters may then be used for different purposes, such as e.g., informing users about carbon footprint of offered mobile services of operators, as well as for traffic engineering purposes, allowing a network orchestrator to drive UE data traffic over greener mobile service options. This is particularly useful when a cloud network infrastructure is a shared or multi-tenant framework, and an operator may require the same certifications from their cloud provider.

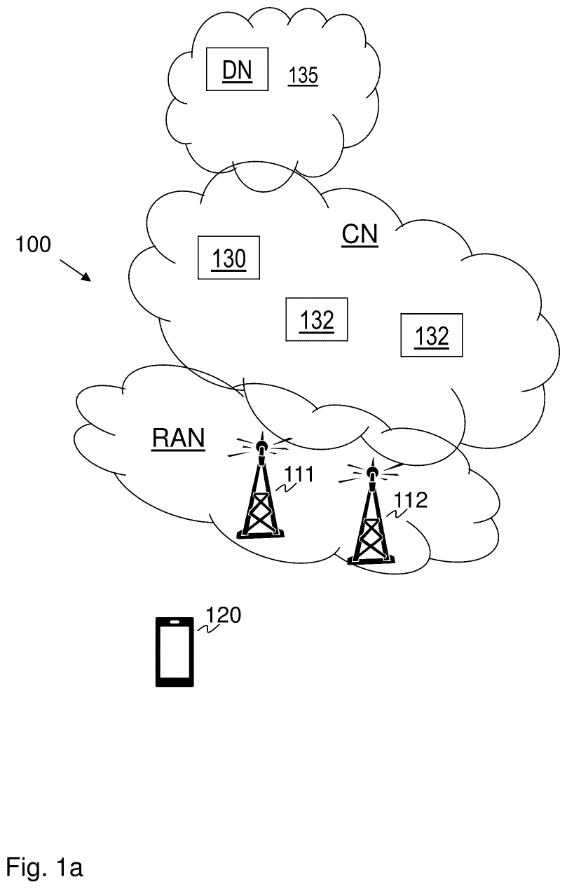

FIG. 1a is a schematic overview depicting a telecommunications network 100, such as e.g. a wireless communications network, wherein embodiments herein may be implemented. The communications network 100 comprises one or more RANs and one or more CNs. The communications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes, such as a network node 111, and a network node 112 operate in the telecommunications network 100. Each of the network nodes 111, 112 e.g. provides mobile coverage for a number of cells and may use these cells for communicating with other network nodes. Each of the network nodes 111, 112 may be a transmission and reception point e.g. a network node, a radio access network node such as a base station, a radio base station, a NodeB (NB), an evolved Node B (eNB, eNodeB, eNode B), next generation eNB (ng-eNB), an NR/g Node B (gNB, Next Generation NodeB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the network node 111, 112 depending e.g. on the radio access technology and terminology used.

UEs, such as the UE 120, operate in the telecommunications network 100. The UE 120 may e.g. be an NR device, a mobile station, a wireless terminal, an IoT device, an IoS device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, a Vehicle-to-Network (V2N) device, a Wi-Fi device, an LTE device, a non-access point (non-AP) STA, a STA, that communicates via a base station such as e.g. the network nodes 111, 112 and one or more Access Networks (AN), e.g. RAN, to one or more core networks (CN). It should be understood by the skilled in the art that the term UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

Network nodes such as a network node 130, and optionally one or more other network nodes 132, operate in the telecommunications network 100. The network node 130 is performing some of the methods described herein. In some of these embodiments these methods are performed by a network function in, or associated with, the network node 130. Each of the network node 130, and optionally one or more other network nodes 132 may be a network function node and may support the 4G, 5G and future 6G Core Network functions of the Mobile network, according to 3GPP.

Methods herein may in one aspect be performed by the network node, e.g. by a network function in the network node 130. In another aspect by the UE 120. As an alternative, a Distributed Node (DN) and functionality, e.g. comprised in a cloud 135 as shown in FIG. 1a, may be used for performing or partly performing the methods of embodiments herein.

The cloud 135 may comprise a cloud network infrastructure. A cloud network infrastructure may e.g. be a collection of hardware and software elements such as computing power, networking, storage, and virtualization resources needed to enable cloud computing in a telecommunications network such as e.g. the telecommunications network 100.

The network node 130 may use a Core Network Function Embodiments for the method according to embodiments herein, referred to as Telecom Energy Efficiency Agent (TEEA), e.g. to allow seamless querying and pushing data from and into the distributed blockchain and expose the energy rating parameters as Key Performance Indicators (KPI) s to other 3GPP functions. FIG. 1b depicts a TEEA of the network node 130 and a blockchain e.g., referred to as Distributed Ledger Technology (DLT) Public Register of Network Telecommunication Energy Efficiency (PRoNTEE) in 5G network according to an example scenario. In FIG. 1b, the network node 130 comprises a new TEEA function that is used by the network node 130 to collect energy efficiency rating parameters of the available resources such as the network slices 160, e.g., available for a certain coverage area. The TEEA may be in charge of associating the energy rating parameters, such as e.g., PUE with the available resources, e.g. network slices available in each coverage area.

The energy rating parameters, also referred to as Key Performance Indicators (KPI) s, also referred to as PUE, may be collected by the network node 130, e.g. by its TEEA, from network functions 150 such as e.g. the Physical Network Function (PNF) and the Virtualized Network Function (VNF) based on the energy efficiency of their hosting system, e.g., purpose-built hardware or server running virtualized network functions.

Implementing TEEA as an integrated CN function may provide energy rating parameters in quasi real time for the other network functions to allow the selection of the most efficient resources. The parameters, e.g., comprising rating criteria, may be used for non-Real Time Communication (RTC) orchestration, e.g., network slicing qualification, and for an RTC controller, e.g., for service allocation and UE exposure.

Example embodiments here provide a distributed blockchain technology, also referred to as ledger technology, shared across different network nodes 130, 132 e.g. network nodes owned by operators. This is in order to store and calculate the energy rating parameters, e.g., energy efficiency rating, green energy percentage and geographically origin of their available resources, and store them as smart contracts, e.g., referred to as Energy Rating Smart Contract (ERSC).

The smart contracts may stipulate the energy rating parameters, e.g. the energy efficiency algorithm, between network nodes 130, 132, such as Mobile Network Operator nodes and a Certification Authority for Energy Efficiency Auditing. This operation may leverage on existing prior art for blockchain registration and validation.

According to some embodiments herein, this method may require independent Auditors, other MNOs and Government Authorities to act as DLT Miners to validate each smart contract transaction before adding it to the DLT, to allow peer-review and consensus approval. A Miner is a network function implemented on a server or a cloud infrastructure, participating in the validation and verification of transactions on the blockchain. It adds new blocks to the existing chain and ensures that these additions are accurate and approved by the majority of the other Miners. A Miner when used herein verifies that the smart contract performs the common energy rating criteria for the network resource, the block with the smart contract is added to the blockchain only if the majority of the Miners approve the rating criteria for the selected resource. This does not require exposing the operator data since other miners may only validate the rules and the set of monitored parameters without access to real time data. Additionally, the MNO identity and the logistic parameters may be further encrypted to hide any company confidential data.

The calculated energy rating parameters may be stored in the shared blockchain e.g., DLT referred to as PRoNTEE, that uses the above-mentioned ERSC shared by the MNOs.

The sharing of the blockchain is an optional step of the procedure demonstrating the potential applications in energy efficient networks such as also future Energy Efficient networks. It should be noted that any individual MNO may use a private blockchain such as PRoNTEE to certify their own network independently with Auditing Authorities.

Embodiments herein may e.g., comprise the following advantages:

Embodiments herein may be used to develop, sell and deliver hardware, software, services and solutions with excellent sustainability performance and contribute to the sustainable development of society.

The architecture of the telecommunications network 100 may be optimized according to the calculated energy rating parameters, which improves the use of green network elements and using new allocation algorithms that consider as relevant parameters also the new energy rating parameters together with existing Quality of Service (QoS) parameters.

Common energy efficiency certification among different MNO operators creates a competitive push towards optimizing and reducing the carbon footprint for 5G and 6G networks. Using consensus methods, the operators may share and compare publicly their performances and so create a trusted method for subscriber decisions.

Embodiments herein may also create more opportunities for a MNO to attract more and more users to their network. Improving use of green network elements and with energy rating parameters such as “green” allocation algorithms increase the sustainability reducing costs and pollution.

The capability to expose a trustable value of energy efficiency for the available resources such as network resources and network services, e.g., nodes, subscribers, devices, connections, is an enabler for new applications and new models for attracting new users, e.g., UEs. One operator may claim to be the most energy green, the most energy efficient subscribers of an operator can get discounts, the greenest IoT connections may be charged with lower fares and so on.

A number of embodiments will now be described, some of which may be seen as alternatives, while some may be used in combination.

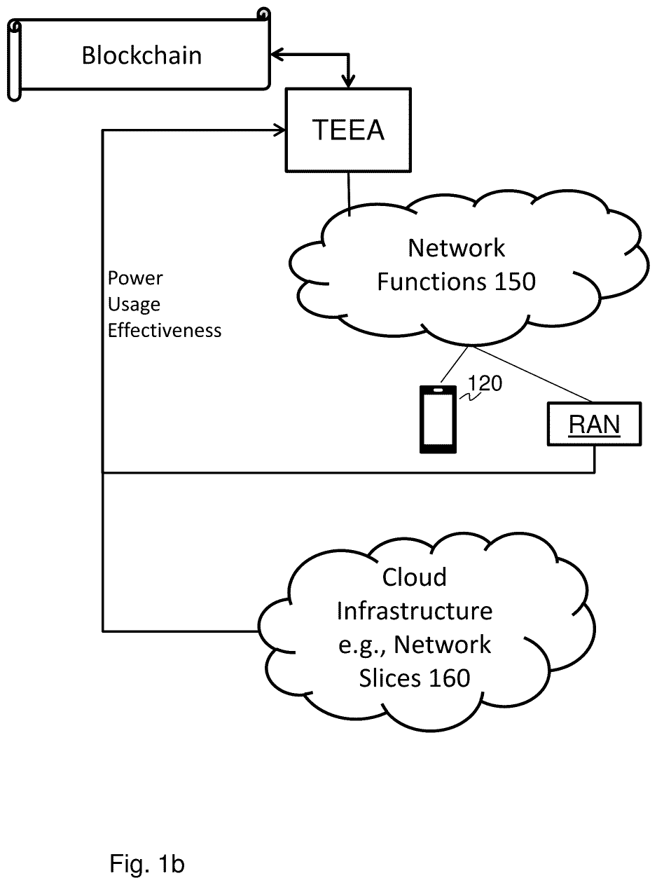

FIGS. 2a and 2b show exemplary embodiments of a method performed by the network node 130. The network node 130 may e.g. be a CN function node. The method is for handling rating of energy efficiency and sustainability of available resources in a telecommunications network 100. Available resources when used herein, e.g. means different types of resources with different grade of energy efficiency and sustainability that are available at least from time to time, for a UE, such as the UE 120, in communications in the telecommunications network 100. The available resources may, e.g. comprise any one or more out of: available network slices, available paths through the telecommunications network 100, available radio cells.

The available resources may comprise available network resources that are managed by the network node 130. This may e.g. mean that the available resources e.g., may be available network resources that are managed by the network node 130, such as e.g. mobile services with their relevant RAN resources and CN services.

The method comprises the following actions, which actions may be taken in any suitable order. Optional actions are referred to as dashed boxes in FIGS. 2a and 2b.

### Action 201

The network node 130 wishes to rate its available resources for communication concerning energy efficiency and sustainability, e.g. for each provided coverage area and for each service type.

The network node 130 obtains rating criteria to be used for rating the energy efficiency and sustainability of the available resources. The rating criteria are obtained from a blockchain in which the criteria are stored encrypted associated to the network node 130. This e.g., means that the network node 130 has access to the blockchain and is able to obtain and encrypt the rating criteria. The rating criteria may be stored encrypted within the blockchain as transactions, e.g. approved by the Miners also referred to as Energy Efficiency Authorities and can only be decrypted by a relevant MNO operator in order to perform its energy efficiency reporting activities. The blockchain validation ensures that the Smart Contract is approved by all the Miners and cannot be changed by the MNO operators.

### Action 202

The network function 130 calculates energy rating parameters relating to the energy efficiency and sustainability of said available resources. The calculation is based on data related to the available resources and according to the obtained rating criteria.

The energy rating parameters may e.g., relate to at least one out of: energy efficiency rating, sustainable energy percentage and energy geographically origin, kind of power used, e.g. low carbon or carbon-free power.

This will be explained more in detail below.

### Action 203

In some embodiments, the network node 130 encrypts the data in the blockchain. The data may comprise any one or more out of: The data related to the available resources used for the calculation of the energy rating parameters, and the second data related to the available resources used for the calculation of the second energy rating parameters.

### Action 204

The network node 130 stores the calculated energy rating parameters as a smart contract in the blockchain. The blockchain is a shared public energy related blockchain. The calculated energy rating parameters may e.g., be made public across different operators. The blockchain enables the UE 120 to obtain one or more resources among the available resources based on the energy rating parameters for an upcoming communication in the telecommunications network 100.

The UE 120 is enabled to obtain the one or more resources among the available resources based on the energy rating parameters in different ways. The UE or a network node such as the network node 130 may select the or more resources among the available resources based on the energy rating parameters.

According to some first embodiments, for example as in use case 1 described below, the UE 120 will e.g., be able to interact with its operator's network to read the information collected and exposed by the smart contract stored in the blockchain. In these first embodiments the blockchain, when accessed by the UE 120 enables the UE 120 to obtain the one or more resources among the available resources by retrieving the energy rating parameters and select the one or more resources based on the retrieved energy rating parameters for the upcoming communication in the telecommunications network 100.

In this way, it is e.g., possible for the UE 120 to select a resource with the best energy efficiency and sustainability among available resources with different energy rating parameters, e.g., according to its assigned user policy. The UE 120 may, e.g. select a resource where the calculated energy rating parameters points to high efficiency and sustainability. In an example scenario this may e.g. be a resource based on wind power, e.g. provided by a base station operated by wind power.

In some embodiments, the smart contract is validated by an authority before it is stored in the blockchain. In some of these embodiments, the energy efficiency and sustainability of the available resources related to the smart contract are certified when validated by the authority.

### Action 205

In these second embodiments, the network node 130 accesses the blockchain and retrieves the energy rating parameters.

### Action 206

In these second embodiments, the network node 130 further selects the one or more resources among the available resources based on the retrieved energy rating parameters.

### Action 207

In these second embodiments, the network node 130 then allocates the selected one or more resources to the UE 120 for the upcoming communication in the telecommunications network 100. In this way, the UE 120, is enabled to obtain the one or more resources among the available resources.

The energy rating parameters may changes over time. E.g., the resource based on wind power according to the example scenario, may e.g. have a very low energy efficiency since the weather has become calm. It may be an advantage to calculate new energy rating parameters and update the smart contract in the blockchain accordingly. The method may further comprise the following actions 208 and 209 to be repeated at one or more proceeding times.

### Action 208

The network node 130 may calculate second energy rating parameters relating to the energy efficiency and sustainability of said available resources, based on current second data related to the available resources and according to the obtained rating criteria. The word second in second energy rating parameters is only used to differentiate from the earlier calculated energy rating parameters. Further, wording current second in current second data related to the available resources is only used to differentiate from the earlier data related to the available resources at an earlier time.

Also, the second energy rating parameters may relate to at least one out of: energy efficiency rating, sustainable energy percentage and energy geographically origin, kind of power used, e.g. low carbon or carbon-free power.

### Action 209

The network node 130 may then replace the recently stored energy rating parameters with the calculated second energy rating parameters in the smart contract of the blockchain.

The blockchain enables the UE 120 to obtain one or more second resources among the available resources based on the retrieved second energy rating parameters for an upcoming communication in the telecommunications network 100.

According to some of the first embodiments, the blockchain, when accessed by the UE 120 enables the UE 120 to obtain the one or more second resources among the available resources by retrieving the second energy rating parameters and select the one or more second resources based on the retrieved second energy rating parameters for the upcoming communication in the telecommunications network 100.

According to some of the second embodiments, for example as in use case 2 described below, the network node performs the Actions 210-212 below.

### Action 210

In these second embodiments, the network node 130 accesses the blockchain and retrieves the energy rating parameters.

### Action 211

In these second embodiments, the network node 130 further selects the one or more second resources among the available resources based on the retrieved second energy rating parameters.

### Action 212

In these second embodiments, the network node 130 then allocates the selected second one or more resources to the UE 120 for the upcoming communication in the telecommunications network 100. In this way, the UE 120, is enabled to obtain the one or more second resources among the available resources.

In some embodiments, the blockchain further comprises other energy rating parameters relating to other available resources available from respective other network nodes 132. That may mean that the blockchain comprises energy rating parameters relating to available resources from the network node 130 and available other resources from some other network nodes 132. In these embodiments, UE 120 is enabled to retrieve the energy rating parameters and select resources among the available resources based on the energy rating parameters for the upcoming communication. This may e.g. comprise that the UE 120 or the network node 130 are enabled to retrieve the energy rating parameters and the other energy rating parameters, and then select resources among the available resources and the other available resources based on the energy rating parameters and the other energy rating parameters for the upcoming communication.

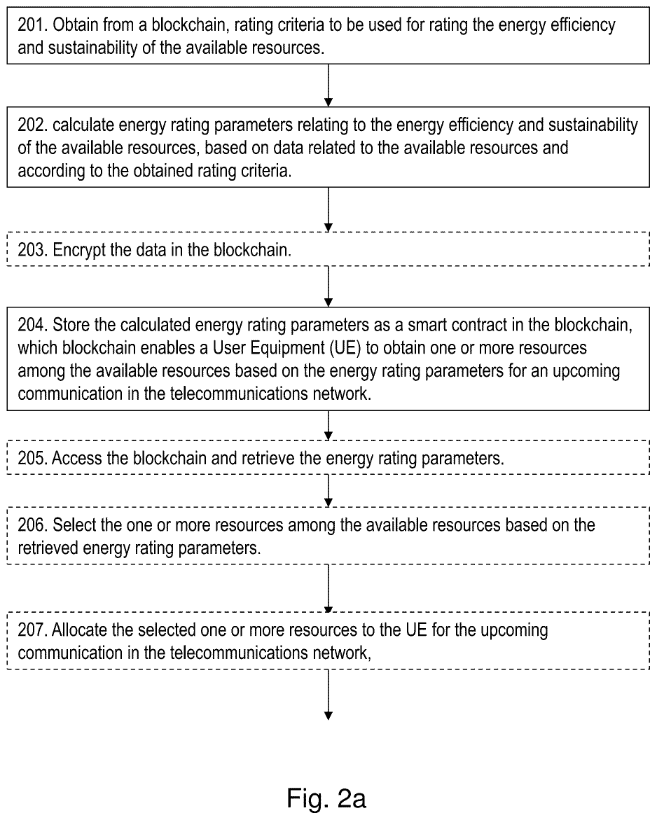

FIG. 3 shows exemplary embodiments of a method performed by the UE 120 for selecting resources in the telecommunications network 100.

The method comprises the following actions, which actions may be taken in any suitable order.

### Action 301

The UE 120 accesses a blockchain. One or more calculated energy rating parameters are stored as one or more smart contracts in the blockchain. The blockchain is a shared public energy related blockchain. The UE 120 will e.g., be able to interact with its operator's network to read the information collected and exposed by the smart contract stored in the blockchain.

The one or more smart contracts may be validated by an authority before they are stored in the blockchain. The energy efficiency and sustainability of the available resources related to the one or more smart contracts may be certified when validated by the authority.

### Action 302

The UE 120 retrieves energy rating parameters from the blockchain. The energy rating parameters relate to energy efficiency and sustainability of available resources in the telecommunications network 100.

The blockchain may comprise energy rating parameters relating to available resources from the network node 130 and available other resources from some other network nodes 132.

The energy rating parameters may relate to at least one out of: energy efficiency rating, sustainable energy percentage and energy geographically origin, kind of power used, e.g. low carbon or carbon-free power.

The available resources may comprise any one or more out of: available network slices, available paths through the telecommunications network 100, and available radio cells.

### Action 303

The UE 120 selects one or more resources among the available resources based on the retrieved energy rating parameters for an upcoming communication in the telecommunications network 100.

As mentioned above, it is e.g., possible for the UE 120 to select a resource with the best energy efficiency and sustainability among available resources with different energy rating parameters. The UE 120 may, e.g. select a resource where the calculated energy rating parameters show a high efficiency and sustainability. In an example scenario this may e.g. be a resource based on wind power, e.g. provided by a base station operated by wind power.

### Action 304

The UE 120 sends a request to a network node 130, 132 managing the selected one or more resources. The request requests to set up a communication over the selected one or more resources.

Embodiments herein such as the embodiments mentioned above will now be further described and exemplified. The text below is applicable to and may be combined with any suitable embodiment described above.

The method is run by the network node 130, such as e.g. a network function in the network node 130 such as e.g. by individual operators or possibly shared among Mobile Network Operators and Government Authorities for Telecom operations. In some embodiments, a common certification reference is provided for mobile networks such as the telecommunications network 100, and their network services.

Some embodiments herein provide a new methodology, implemented within new Core Network Functions, APIs and smart contracts such as ERSC, definition to audit energy efficiency and sustainability of mobile networks such as the telecommunications network 100, to be integrated over a blockchain framework.

To implement example embodiments herein, a standard template used for network slice classification may be enhanced, introducing a new parameter tracking the energy rating parameters of the cloud infrastructure used to run the CN and RAN services.

Just for the sake of clarity, examples in the text herein refer to the PUE as example of an indicator to be used for the energy rating parameters by the MNO. PUE is an energy rating parameter because it rates the waste of energy facility such as e.g., cooling, lights, etc. in a data center. So this is a good way to take a decision in an algorithm, i.e. the lower the better. Prior art, as described in Measuring energy efficiency of data centers with the PUE https://www.tempco.it/blog/en/7330/measuring-energy-efficiency-of-data-centers-with-the-pue [Ref. 4], already provides useful tools to evaluate a data center efficiency by calculating its actual energy rating parameters, e.g., its actual PUE.

It is noted that PUE is just one of the possible embodiments as it is a generally recognized method for monitoring the energy efficiency of a Cloud Network Infrastructure (CNIS) and it is not the subject of embodiments herein. Other methods may be used as alternative embodiments.

As part embodiments, a method provided to collect, certify and publish common rating criteria across different mobile network operators' nodes, e.g., MNO and virtual MNO nodes, by implementing an algorithm related to the energy rating parameters in smart contracts stored in the blockchain, e.g. named ERSC in the context of embodiments herein. Using the same smart contract method, it's also possible to share other energy efficiency parameters that might be defined by relevant standards.

Embodiments herein may implement a continuous and dynamic update of the energy rating parameters, also referred to as energy efficiency ratings, due to a frequent change of conditions and refresh of the hardware in an operator network, e.g. comprised in the telecommunications network 100, via new transactions registered in a blockchain, also referred to as storing calculated energy rating parameters as a smart contract in the blockchain.

Each Core Network service may be located and mapped against its underlying Cloud Network Infrastructure resources so that it's possible to determine its associated energy efficiency.

At the same time, according to some embodiments herein, any data used for the calculation of the rating may safely be encrypted in the blockchain to keep the required confidentiality for each telecommunication operation.

The CN may provide a new core service function to publish the energy efficiency rating parameters for the available resources such as e.g., mobile services in each coverage area, allowing the UE 120 to select the resources according to its assigned user policy.

The CN and the RAN may use the new values of the energy rating parameters to optimize the network architecture and the UEs allocation within each MNO to minimize the carbon footprint of the mobile network.

It is noted that such algorithms are not part of embodiments herein, such as Network Controllers and Orchestrators, but they may advantageously exploit the energy rating parameters provided by embodiments herein.

Energy rating evaluation, for example the PUE as described above or the Radio Energy Performance (Radio EP) as described in Green Future Networks—Network Energy Efficiency—v1.1 (Jul. 12, 2021) https://www.ngmn.org/wp-content/uploads/211009-GFN-Network-Energy-Efficiency-1.0.pdf [Ref. 3], may be calculated by using existing methods and prior art criteria, so they are out of embodiments herein. Green energy percentage and geographically origin values may be taken by the MNO from their energy providers or in case of self-produced energy by their selves and processed according to the rules defined in the ERSC.

The rating criteria used for rating are stored encrypted within the blockchain as transactions and the energy rating parameters are made public across different operators such as e.g. the network nodes 130, 132. The UE 120 will be able to interact with its operator's network to read the information about the energy rating parameters collected and exposed by the smart contract, e.g. the ERSC stored in the blockchain.

The information may be stored as smart contracts in the blockchain may also be exposed at network level to implement analytics and new applications supporting new business model based on energy efficiency.

The calculated energy rating parameters are e.g., stored in the blockchain e.g., in a shared register called PRoNTEE as mentioned above, using the smart contracts, e.g., the ERSC available for the network nodes 130, 132, such as all MNOs. The authority may validate the energy rating parameters, e.g. the ERSC parameters, used to perform the calculation of the energy rating parameters based on the data related to the available resources such as the measurement history of the MNO.

The energy rating parameters such as the PUE and other energy parameters stored in the smart contract, e.g., the PRoNTEE are available to the UE 120 and other UEs to select, according to their requirements, the resource such as e.g., the network that offers the better combination of sustainability (energy parameters green) and serviceability (QoS).

The energy rating parameters may also be used by network node 130, such as the MNO, to create the telecommunications network 100 Infrastructure, such that the energy rating parameters values have to be considered in the telecommunications network architecture. For instance, if it is possible to position a base station such as the network nodes 111, 112, where it is possible to make it energetically autonomous, or where a green power is available.

The network node 130, e.g., the MNO, may at a UE allocation request, e.g., a UE 120 allocation request, also consider the energy rating parameters, such that the actual allocation algorithms are improved. Some embodiments herein may enable the possibility to weight prior art parameters (QoS), also referred to as the data related to the available resources, and the energy rating parameters according to embodiments herein enabling each UE allocation, e.g. the UE 120 allocation, to be performed according to the UE requirements. The UE connection billing may also be impacted, so that green allocation will pay less of full QoS allocation.

In some embodiments, the blockchain, also referred to as the distributed ledger, adopts a private blockchain method that may be run either by individual operators or possibly shared among Mobile Network Operators and Government Authorities for Telecom operations. The purpose of this may be to have a common certification reference for the mobile networks and their network services.

Some embodiments herein provide a new methodology, implemented within new Core Network Functions, APIs and the ERSC definition to audit the Energy Efficiency of the telecommunications network 100 to be integrated over a framework of the blockchain.

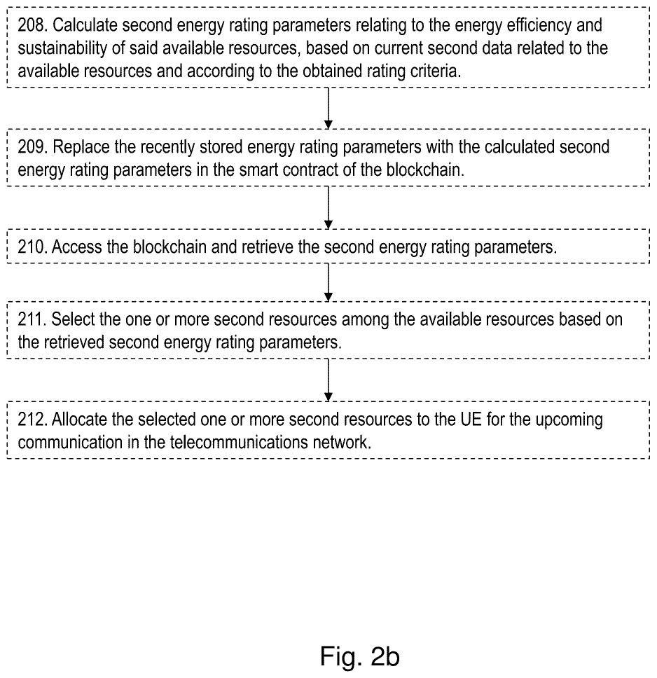

Use Case 1 relates to UE 120 selection of a resource represented by a network slice based on the energy rating parameters such as the PUE in an example scenario. This Use Case 1 is shown in FIG. 4. The UE 120 may need a network slice, before deciding among the MNOs such as the network nodes 130, 132 covering a UE 120 area, the UE 120 consults the blockchain to verify which MNO that provides an efficiency closest to a requested one.

With the calculated energy rating parameters retrieved from the blockchain, the UE 120 may decide the MNO to require the network slice. This means that the algorithms parts of the software installed in the UE 120, e.g. part of its Operating System, may make the decision to choose the greenest and most sustainable network slice based on the user settings of the software.

### Pre-Requisites of the Example Scenario:

(1) The energy rating parameters 401 such as e.g., the PUE, of different network nodes such as the network node 132 are available in the network of the network node 130, e.g. in the blockchain also referred to as public register and/or PRoNTEE.

(2) The energy rating parameters 402 such as e.g. the PUE, calculated by the network node 130 are thus also available in the blockchain, which may be continuously updated from blockchain transactions.

(3) The UE 120 is embedded with software provided by the network node 130, e.g. an MNO.

### Sequence:

In Step 1 the UE 120 accesses the blockchain, e.g. the PRoNTEE for the best available energy efficient and sustainable network slice, e.g. in an area within range by the UE 120 such as the network of the network node 130. offering a specific service, Sx. See the dotted arrow in FIG. 4. This is similar to and may be combined with Action 301 described above.

In Step 2, the UE 120, such as the UE 120 software, searches among the available network slices with regard to their respective energy rating parameters, for the best energy efficient and sustainable network slice (ns). The best energy efficient and sustainable network slice (ns) may e.g., be a network slice that is optimal or most suitable for the UE 120 according to its policy rules. A simple formula like the following may be used: PUE-ns-best=min (PUE-ns1, PUE-ns2, . . . , PUE-nsn). This is similar to and may be combined with Action 302 described above.

In Step 3, the UE 120 selects the network slice with the best energy efficient and sustainable network slice, e.g. the PUE-ns-best. The best energy efficient and sustainable network slice (ns) is in this example referred to as PUE-ns-best which e.g., may be the network slice with the smallest PUE. This is similar to and may be combined with Action 303 described above.

In FIG. 4, the network node 130 performs the selection of resources, wherein the resources are represented by paths. E.g., the best Energy Efficiency Path (EEP) is selected in some other example scenarios.

### Pre-Requisites:

(1) UE 120 settings are configured to do automatic selection of path, e.g. EEP, in the network of the network node 130.

(2) Algorithms are configured in the network node 130 to select the best path, e.g. EEP according to the energy rating parameters registered in the blockchain, e.g. the PRoNTEE.

(3) The network node 130 is configured to allocate the UE 120 according to a selected path, e.g. EEP path.

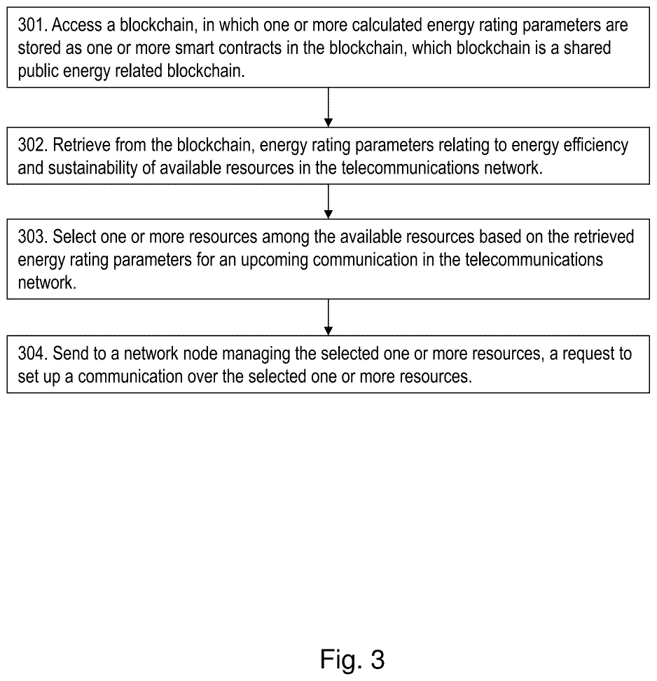

A first example scenario of this Use Case is shown in FIG. 5 depicting an example of UE allocation with EEP.

In Step 1 the UE 120 requests access to the network node 130, e.g. an MNO.

In Step 2 the network node 130 accesses the blockchain 500 to retrieve the energy rating parameters. This is similar to and may be combined with Action 205 described above. It further and sets, such as defines and associates the best allocation of path as possible according to the UE 120 energy setting and to own calculated energy rating parameters. This may be performed by using existing allocation formulas including also the calculated energy rating parameters, according to e.g. old and new, updated parameters, which may be associated a weight, the higher the weight is the higher is the importance of the considered parameter.

In Step 3 the network node 130 selects the best allocation of path according to the UE requirements and calculated energy rating parameters. This is similar to and may be combined with Actions 206 and 207 described above.

In Step 4, the network node 130 may then store, together with the data related to the available resources, also the UE energy setting and the energy efficiency connection, such that e.g., an MNO e.g., the network node 130, can adopt a new price policy based on green use of energy.

In FIG. 5, depicting an example with base stations, e.g., the network nodes 111, 112, with different energy efficiency.

For simplicity the network nodes 111, 112 are characterized by only two rating parameters, an energy rating parameter and one parameter related to QoS, for signal power the higher the better, and another by energy Efficiency, for PUE, the lower the better.

At a UE allocation request from the UE 120, the path is to be allocated not only considering QoS data, but also considering the retrieved energy rating parameters. In FIG. 5, the Signal Power of the different network nodes 111 and 112 is medium in the network node 111 and high in the network node 112. In FIG. 5 the PUE is shown as low for the network node 111 and high for the network node 112.

The UE 120 requirements about energy efficiency and sustainability may be stored in the network node 130, e.g. a Unified Data Manager (UDM), or may be included in the allocation request.

In FIG. 5 two possible paths are shown as dashed lines, one through the network node 112 which has a high signal power, or in general a High QoS, (and would in Prior art be the one selected for default). The other path includes the network node 111, this path has a medium signal power value, i.e., an acceptable QoS, but not the best possible, and a low PUE, i.e. a more efficient energy use, if the UE 120 requests to consider also energy efficiency, this path may be selected.

A network operator such as the network node 130 may e.g., entice UEs to use EEP with an effective pricing policy and informing about the energy saving and pollution reduction obtained with EEP.

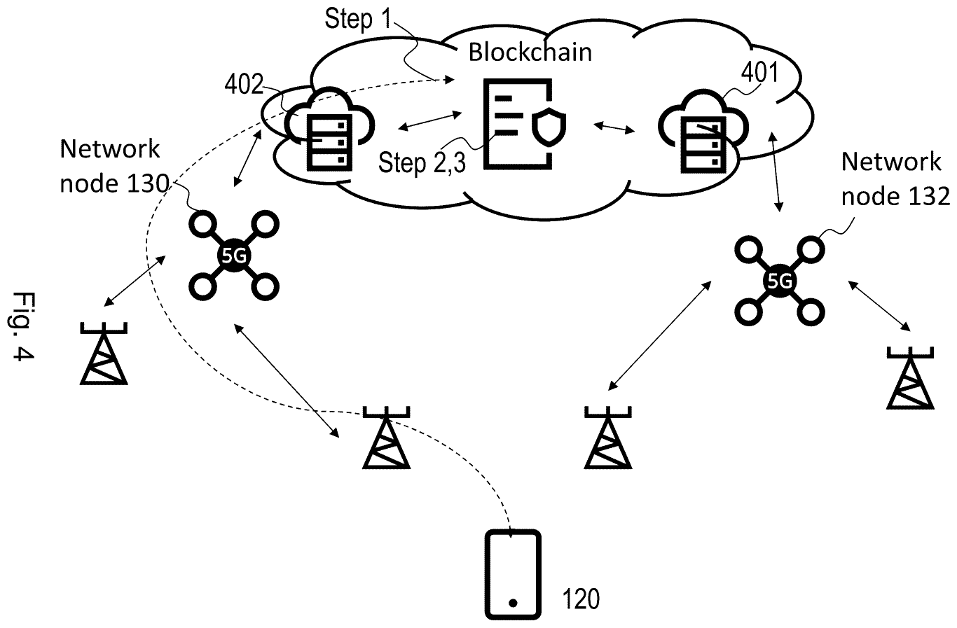

The example in FIG. 6, shows a UE, such as the UE 120 covered by two network nodes 111, and 112, of the same MNO such as the network node 130. In FIG. 6, the Signal Power of the different network nodes 111 and 112 is represented by a respective circle indicative of the QoS, which is medium in the network node 111 and high in the network node 112.

Also in this example in FIG. 6 two possible paths are shown as dashed lines, one through the network node 112 which has a high signal power, or in general a High QoS, (and would in Prior art be the one selected for default). The other path includes the network node 111, this path has a medium signal power value, i.e., an acceptable QoS, but not the best possible, and a low PUE, i.e. a more efficient energy use, if the UE 120 requests to consider also energy efficiency, this path may be selected.

In this example scenario, the network node 111 may be located outside the center of a city, and may use green energy, for example: wind energy, photovoltaic energy, and do not compete with industries for the use of energy. So the network node 111 may be considered a green base station.

In this example scenario, the network node 112 may be located in the center of a city and may need an external power provider and compete with all other users, e.g., industries, people for the energy. It may also be subjected to congestion in busy hours, but is very close, and it may provide a high Signal Power to UEs. The network node 112 cannot be considered as a green base station.

Use of EEP through the network node 111, when possible and providing an adequate QoS, it is suggested for reducing telecom energy costs, and environment cost.

To perform the method actions above, network node 130 is configured to handle rating of energy efficiency and sustainability of available resources in a telecommunications network 100.

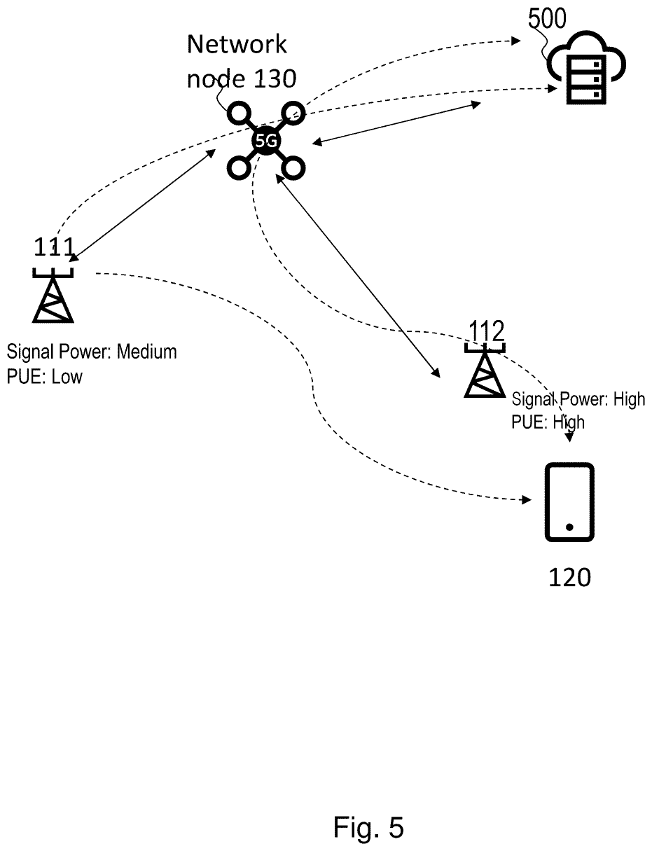

The network node 130 may comprise an arrangement depicted in FIG. 7. The network node 130 may comprise an input and output interface 700 configured to communicate in the wireless communications network 100, e.g., with the UE 120 and the network nodes 111, 112. The input and output interface 700 may comprise a wireless receiver not shown, and a wireless transmitter not shown.

The network node 130 is further configured to obtain rating criteria to be used for rating the energy efficiency and sustainability of the available resources, wherein the rating criteria are obtained from a blockchain in which the criteria are stored encrypted associated to the network node 130.

The network node 130 is further configured to calculate energy rating parameters relating to the energy efficiency and sustainability of said available resources, based on data related to the available resources and according to the obtained rating criteria.

The network node 130 is further configured to store the calculated energy rating parameters as a smart contract in the blockchain, which blockchain is a shared public energy related blockchain. The blockchain is adapted to enable the UE 120 to obtain one or more resources among the available resources based on the energy rating parameters for an upcoming communication in the telecommunications network 100.

The network node 130 may further being configured to perform the following actions to be repeated at one or more proceeding times:
Calculate second energy rating parameters relating to the energy efficiency and sustainability of said available resources, based on current second data related to the available resources and according to the obtained rating criteria, and
replace the recently stored energy rating parameters with the calculated second energy rating parameters in the smart contract of the blockchain. The blockchain is adapted to enable the UE 120 to obtain one or more second resources among the available resources based on the second energy rating parameters for an upcoming communication in the telecommunications network 100.

In some embodiments, the network node 130 is further configured to: Access the blockchain and retrieving the energy rating parameters and/or second energy rating parameters, select the one or more resources and/or one or more second resources among the available resources based on the retrieved energy rating parameters and/or second energy rating parameters, and allocating the selected one or more resources and/or one or more second resources to the UE 120 for the upcoming communication in the telecommunications network 100, and thereby enabling the UE 120 to obtain the one or more resources and/or or one or more second resources, among the available resources.

In some embodiments, the blockchain when accessed by the UE 120, enables the UE 120 to obtain the one or more resources among the available resources by retrieving the energy rating parameters and select the one or more resources based on the retrieved energy rating parameters for the upcoming communication in the telecommunications network 100.

The network node 130 may further being configured to: encrypt in the blockchain, any one or more out of: The data related to the available resources used for the calculation of the energy rating parameters, and the second data related to the available resources used for the calculation of the second energy rating parameters.

In some embodiments, any one or more out of: the energy rating parameters and the second energy rating parameters, are adapted to be related to at least one out of: energy efficiency rating, sustainable energy percentage and energy geographically origin, kind of power used.

The blockchain may further be adapted to comprise other energy rating parameters relating to other available resources available from respective other network nodes 132. In these embodiments enabling the UE 120 to retrieve the energy rating parameters and select resources among the available resources based on the energy rating parameters for the upcoming communication is adapted to comprise: enabling the UE 120 to retrieve the energy rating parameters and the other energy rating parameters and select resources among the available resources and the other available resources based on the energy rating parameters and the other energy rating parameters for the upcoming communication.

The available resources are adapted to comprise any one or more out of: available network slices, available paths through the telecommunications network 100, and available radio cells.

The smart contract may be adapted to be validated by an authority before it is stored in the blockchain.

The energy efficiency and sustainability of the available resources related to the smart contract may be adapted to be certified when validated by the authority.

The available resources may be adapted to comprise available network resources managed by the network node 130.

To perform the method actions above, UE 120 configured to select resources in the telecommunications network 100.

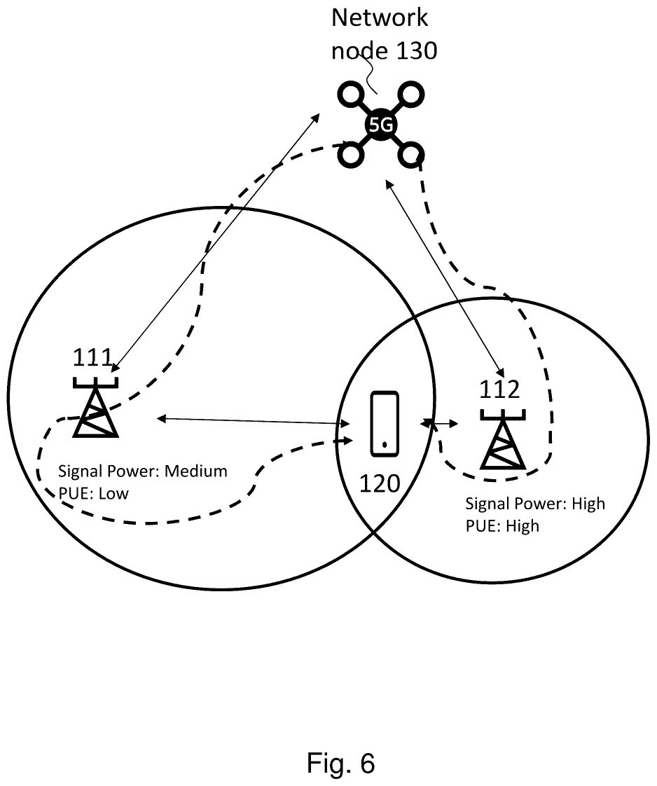

The network node 110 may comprise an arrangement depicted in FIG. 8. The network node 110 may comprise an input and output interface 800 configured to communicate in the telecommunications network 100, e.g., with any of the network nodes 111, 112, and 130. The input and output interface 800 may comprise a wireless receiver not shown, and a wireless transmitter not shown.

The network node 110 is further configured to access a blockchain, wherein one or more calculated energy rating parameters are stored as one or more smart contracts in the blockchain, which blockchain is a shared public energy related blockchain.

The network node 110 is further configured to retrieve from the blockchain, energy rating parameters relating to energy efficiency and sustainability of available resources in the telecommunications network 100.

The network node 110 is further configured to select one or more resources among the available resources based on the retrieved energy rating parameters for an upcoming communication in the telecommunications network 100.

The network node 110 is further configured to send to a network node 130 managing the selected one or more resources, a request to set up a communication over the selected one or more resources.

The energy rating parameters may be adapted to relate to at least one out of: energy efficiency rating, sustainable energy percentage and energy geographically origin, and kind of power used.

The available resources are adapted to comprise any one or more out of: available network slices, available paths through the telecommunications network 100, and available radio cells.

In some embodiments, one or more smart contracts may be adapted to be validated by an authority before they are stored in the blockchain. In some of these embodiments, the energy efficiency and sustainability of the available resources related to the one or more smart contracts are adapted to be certified when validated by the authority.

The embodiments herein may be implemented through a respective processor or one or more processors, such as the respective processor 710 of a processing circuitry in the network node 130 depicted in FIG. 7, and processor 810 of a processing circuitry in the UE 120 depicted in FIG. 8 together with respective computer program code for performing the functions and actions of the embodiments herein. The program code mentioned above may also be provided as a computer program product, for instance in the form of a data carrier carrying computer program code for performing the embodiments herein when being loaded into the respective network node 130 and UE 120. One such carrier may be in the form of a CD ROM disc. It is however feasible with other data carriers such as a memory stick. The computer program code may furthermore be provided as pure program code on a server and downloaded to the network node 130 and UE 120.

The network node 130 and UE 120 may further comprise a respective memory 720 and memory 820 comprising one or more memory units. The respective memory 720 and memory 820 comprises instructions executable by the processor in the respective network node 130 and UE 120. The respective memory 720 and memory 820 are arranged to be used to store e.g., rating criteria, energy rating parameters, information, indications, data, configurations, communication data, and applications to perform the methods herein when being executed in the respective network node 130 and UE 120.

In some embodiments, a respective computer program 730 and computer program 830 comprises instructions, which when executed by the respective at least one processor 710 and processor 810, cause the at least one processor of respective first network node 130 and UE 120 to perform the actions above.

In some embodiments, a respective carrier 740 and carrier 840 comprises the respective computer program 730 and computer program 830, wherein the respective carrier 740 and carrier 840 is one of an electronic signal, an optical signal, an electromagnetic signal, a magnetic signal, an electric signal, a radio signal, a microwave signal, or a computer-readable storage medium.

Those skilled in the art will appreciate that units in the respective network node 130 and UE 120 described above may refer to a combination of analog and digital circuits, and/or one or more processors configured with software and/or firmware, e.g. stored in the respective network node 130 and UE 120, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a System-on-a-Chip (SoC).

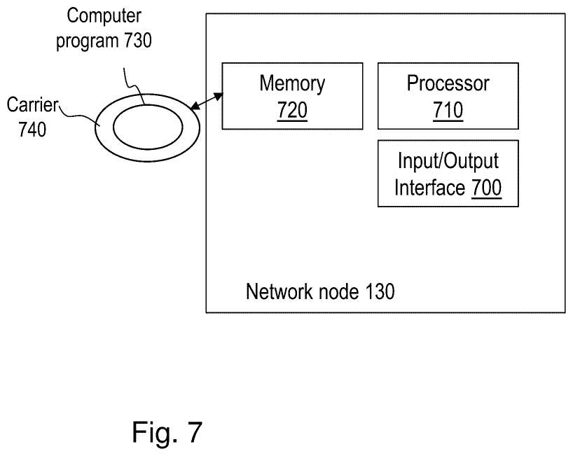

With reference to FIG. 9, in accordance with an embodiment, a communication system includes a telecommunication network 3210, such as a 3GPP-type cellular network, e.g. wireless communications network 100, which comprises an access network 3211, such as a radio access network, and a core network 3214. The access network 3211 comprises a plurality of base stations 3212a, 3212b, 3212c, e.g., the BS 110, such as AP STAs NBs, eNBs, ng-eNB, gNBs or other types of wireless access points, each defining a corresponding coverage area 3213a, 3213b, 3213c. Each base station 3212a, 3212b, 3212c, e.g. network nodes 111, 112, is connectable to the core network 3214 over a wired or wireless connection 3215. A first user equipment (UE), e.g. the UE 120, such as a Non-AP STA 3291 located in coverage area 3213c is configured to wirelessly connect to, or be paged by, the corresponding base station 3212c, e.g., the network node 110. A second UE 3292, e.g., any of the UE 120, such as a Non-AP STA in coverage area 3213a is wirelessly connectable to the corresponding base station 3212a, e.g., the network nodes 111, 112. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 9 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

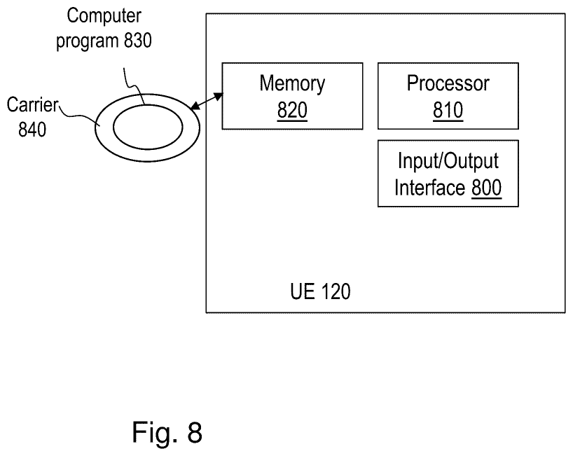

Example implementations, in accordance with an embodiment, of the UE, base station and host computer discussed in the preceding paragraphs will now be described with reference to FIG. 10. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 10) served by the base station 3320. The communication interface 3326 may be configured to facilitate a connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as e.g. the applicable corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

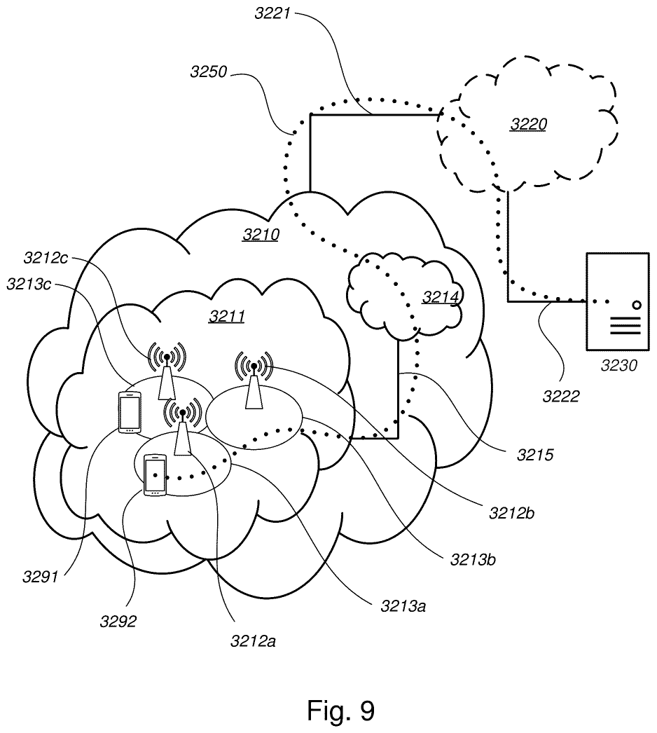

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 11 will be included in this section. In a first Step 3410 of the method, the host computer provides user data. In an optional sub Step 3411 of the first Step 3410, the host computer provides the user data by executing a host application. In a second Step 3420, the host computer initiates a transmission carrying the user data to the UE. In an optional third Step 3430, the base station transmits to the UE the user data which was carried in the transmission that the host computer initiated, in accordance with the teachings of the embodiments described throughout this disclosure. In an optional fourth Step 3440, the UE executes a client application associated with the host application executed by the host computer.

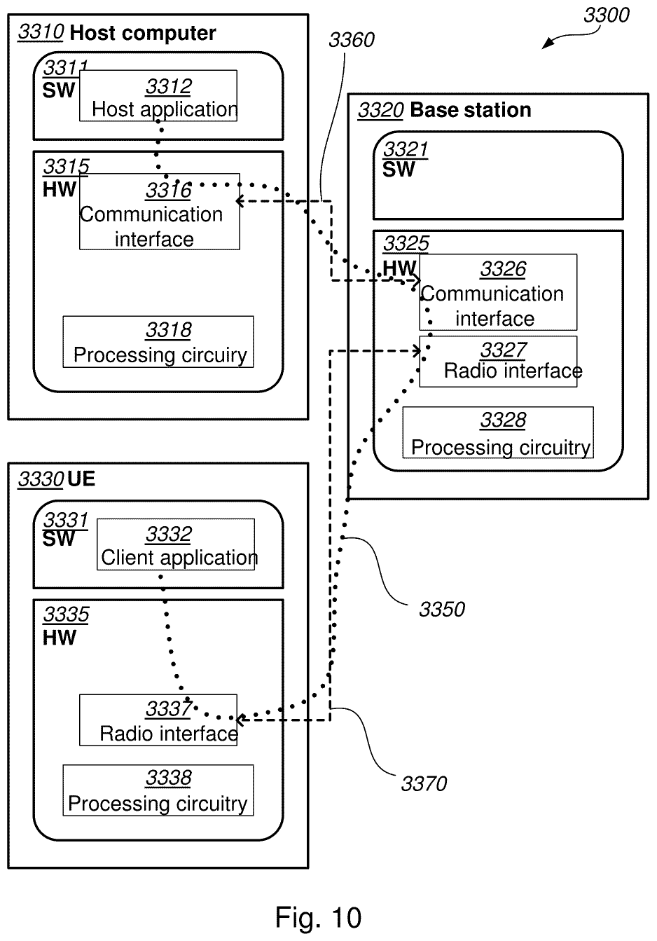

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 12 will be included in this section. In a first Step 3510 of the method, the host computer provides user data. In an optional sub step (not shown) the host computer provides the user data by executing a host application. In a second Step 3520, the host computer initiates a transmission carrying the user data to the UE. The transmission may pass via the base station, in accordance with the teachings of the embodiments described throughout this disclosure. In an optional third Step 3530, the UE receives the user data carried in the transmission.

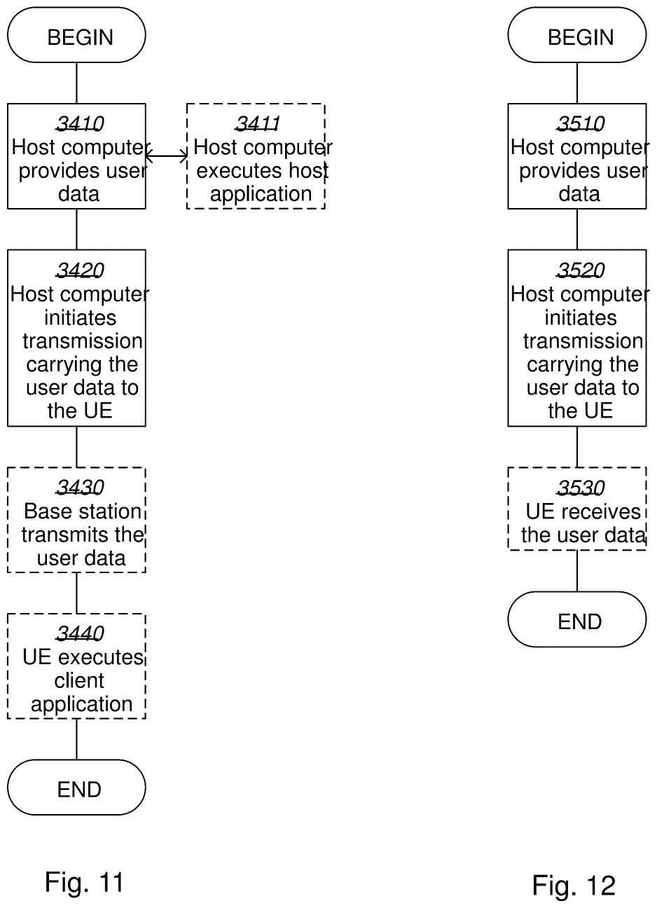

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 13 will be included in this section. In an optional first Step 3610 of the method, the UE receives input data provided by the host computer. Additionally or alternatively, in an optional second Step 3620, the UE provides user data. In an optional sub Step 3621 of the second Step 3620, the UE provides the user data by executing a client application. In a further optional sub Step 3611 of the first Step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third sub Step 3630, transmission of the user data to the host computer. In a fourth Step 3640 of the method, the host computer receives the user data transmitted from the UE, in accordance with the teachings of the embodiments described throughout this disclosure.

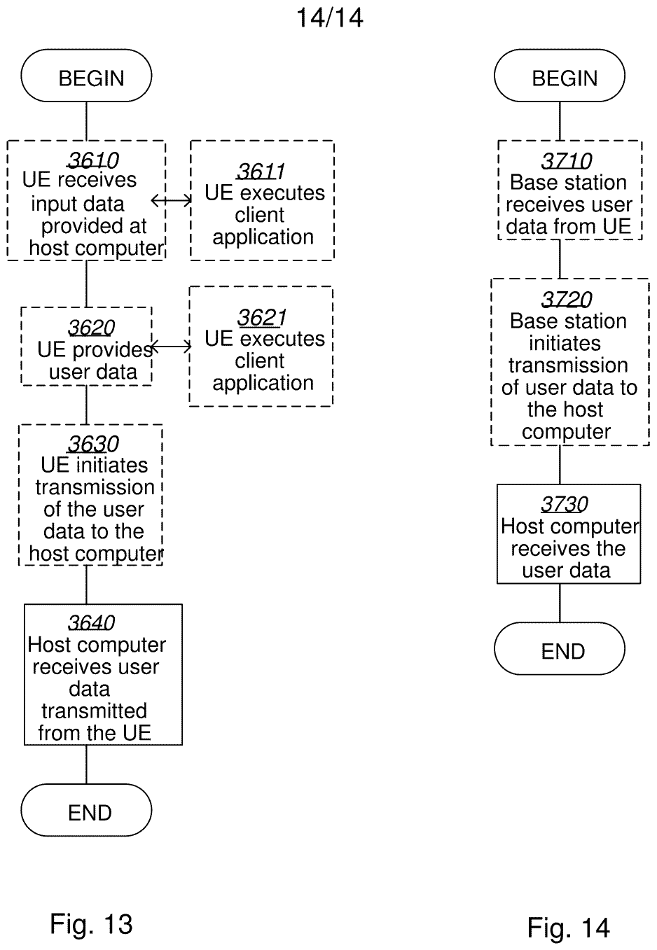

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 14 will be included in this section. In an optional first Step 3710 of the method, in accordance with the teachings of the embodiments described throughout this disclosure, the base station receives user data from the UE. In an optional second Step 3720, the base station initiates transmission of the received user data to the host computer. In a third Step 3730, the host computer receives the user data carried in the transmission initiated by the base station.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

| Abbreviation | Explanation |
|---|---|
| 5G | Fifth generation of cellular mobile communications |
| 6G | Sixth generation of cellular mobile communications |
| AI | Artificial Intelligence |
| AP | Access Point |
| AP STA | Access Point Station |
| BTS | Base Transceiver Station |
| CN | Core Network |
| DCIE | Data Center Infrastructure Efficiency |
| DN | Distributed Node |
| EEP | Energy Efficiency Path |
| eNB | evolved Node B (4G-LTE Radio Node) |
| EP | Energy Performance |
| ERSC | Energy Rating Smart Contract |
| gNB | next generation Node B (5G connection on 5G NR |
| | air interface) |
| HW | Hardware |
| IoS | Internet of Senses |
| IoT | Internet of Things |
| IT | Information Technology |
| IvD | Invention Disclosure |
| LTE | Long Term Evolution |
| ML | Machine Learning |
| MNO | Mobile Network Operator |
| NB | Node B (3G-UMTS Radio Node) |
| ng-eNB | next generation e-Node B (5G connection on 4G LTE |
| | air interface) |
| PRoNTEE | Public Register of Network Telecommunication |
| | Energy Efficiency |
| PUE | Power Usage Effectiveness |
| QoS | Quality of Service |
| RAN | Radio Access Network |
| SW | Software |
| TEEA | Telecommunication Energy Efficiency Agent |
| UE | User Equipment |

1. A method performed by a network node for handling rating of energy efficiency and sustainability of available resources in a telecommunications network, the method comprising:
obtaining rating criteria to be used for rating the energy efficiency and sustainability of the available resources, wherein the rating criteria are obtained from a blockchain in which the criteria are stored encrypted associated to the network node,
calculating energy rating parameters relating to the energy efficiency and sustainability of said available resources, based on data related to the available resources and according to the obtained rating criteria, and
storing the calculated energy rating parameters as a smart contract in the blockchain, which blockchain is a shared public energy related blockchain,
which blockchain enables a User Equipment, UE, to obtain one or more resources among the available resources based on the energy rating parameters for an upcoming communication in the telecommunications network.

2. The method according to claim 1, further comprising the following actions to be repeated at one or more proceeding times:
calculating second energy rating parameters relating to the energy efficiency and sustainability of said available resources, based on current second data related to the available resources and according to the obtained rating criteria, and
replacing the recently stored energy rating parameters with the calculated second energy rating parameters in the smart contract of the blockchain, which blockchain enables the UE to obtain one or more second resources among the available resources based on the second energy rating parameters for an upcoming communication in the telecommunications network.

3. The method according to claim 1, further comprising:
accessing the blockchain and retrieving the energy rating parameters and/or second energy rating parameters,
selecting the one or more resources and/or one or more second resources among the available resources based on the retrieved energy rating parameters and/or second energy rating parameters, and
allocating the selected one or more resources and/or one or more second resources to the UE for the upcoming communication in the telecommunications network, and thereby enabling the UE to obtain the one or more resources and/or or one or more second resources, among the available resources.

4. The method according to claim 1, wherein the blockchain when accessed by a User Equipment, UE, enables the UE to obtain the one or more resources among the available resources by retrieving the energy rating parameters and select the one or more resources based on the retrieved energy rating parameters for the upcoming communication in the telecommunications network.

5. The method according to claim 1, further comprising.
encrypting data in the blockchain, which data comprises any one or more out of:
the data related to the available resources used for the calculation of the energy rating parameters, and
the second data related to the available resources used for the calculation of the second energy rating parameters.

6. The method according to claim 1, wherein any one or more out of: the energy rating parameters and the second energy rating parameters, relate to at least one out of:
energy efficiency rating, sustainable energy percentage and energy geographically origin, kind of power used.

7. The method according to claim 1, wherein the blockchain further comprises other energy rating parameters relating to other available resources available from respective other network nodes, and wherein
enabling the UE or the network node to retrieve the energy rating parameters and select resources among the available resources based on the energy rating parameters for the upcoming communication comprises:
enabling the UE or the network node to retrieve the energy rating parameters and the other energy rating parameters and select resources among the available resources and the other available resources based on the energy rating parameters and the other energy rating parameters for the upcoming communication.

8. The method according to claim 1, wherein the available resources comprise any one or more out of:
available network slices,
available paths through the telecommunications network,
available radio cells.

9. The method according to claim 1, wherein the smart contract is validated by an authority before it is stored in the blockchain.

10. The method according to claim 9, wherein the energy efficiency and sustainability of the available resources related to the smart contract are certified when validated by the authority.

11. The method according to claim 1, wherein the available resources comprise available network resources managed by the network node.

12. (canceled)

13. (canceled)

14. A method performed by a User Equipment, UE, for selecting resources in a telecommunications network, the method comprising:
accessing a blockchain, wherein one or more calculated energy rating parameters are stored as one or more smart contracts in the blockchain, which blockchain is a shared public energy related blockchain,
retrieving from the blockchain, energy rating parameters relating to energy efficiency and sustainability of available resources in the telecommunications network,
selecting one or more resources among the available resources based on the retrieved energy rating parameters for an upcoming communication in the telecommunications network, and
sending to a network node managing the selected one or more resources, a request to set up a communication over the selected one or more resources.

15. The method according to claim 14, wherein the energy rating parameters relate to at least one out of:
energy efficiency rating, sustainable energy percentage and energy geographically origin, kind of power used.

16. The method according to claim 14, wherein
the available resources comprise any one or more out of:
available network slices,
available paths through the telecommunications network,
available radio cells.

17. The method according to claim 14, wherein the one or more smart contracts are validated by an authority before they are stored in the blockchain.

18. The method according to claim 17, wherein the energy efficiency and sustainability of the available resources related to the one or more smart contracts are certified when validated by the authority.

19. (canceled)

20. (canceled)

21. A network node configured to handle rating of energy efficiency and sustainability of available resources in a telecommunications network, the network node further being configured to:
obtain rating criteria to be used for rating the energy efficiency and sustainability of the available resources, wherein the rating criteria are obtained from a blockchain in which the criteria are stored encrypted associated to the network node,
calculate energy rating parameters relating to the energy efficiency and sustainability of said available resources, based on data related to the available resources and according to the obtained rating criteria, and
store the calculated energy rating parameters as a smart contract in the blockchain, which blockchain is a shared public energy related blockchain,
which blockchain is adapted to enable a User Equipment, UE, to obtain one or more resources among the available resources based on the energy rating parameters for an upcoming communication in the telecommunications network.

22. The network node according to claim 21, further being configured to perform the following actions to be repeated at one or more proceeding times:
calculate second energy rating parameters relating to the energy efficiency and sustainability of said available resources, based on current second data related to the available resources and according to the obtained rating criteria, and
replace the recently stored energy rating parameters with the calculated second energy rating parameters in the smart contract of the blockchain,
which blockchain is adapted to enable the UE to obtain one or more second resources among the available resources based on the second energy rating parameters for an upcoming communication in the telecommunications network.

23. (canceled)

24. (canceled)

25. (canceled)

26. (canceled)

27. (canceled)

28. (canceled)

29. (canceled)

30. (canceled)

31. (canceled)

32. A User Equipment, UE, configured to select resources in a telecommunications network, the UE further being configured to:
access a blockchain, wherein one or more calculated energy rating parameters are stored as one or more smart contracts in the blockchain, which blockchain is a shared public energy related blockchain,
retrieve from the blockchain, energy rating parameters relating to energy efficiency and sustainability of available resources in the telecommunications network,
select one or more resources among the available resources based on the retrieved energy rating parameters for an upcoming communication in the telecommunications network, and
send to a network node managing the selected one or more resources, a request to set up a communication over the selected one or more resources.

33. The UE according to claim 32, wherein the energy rating parameters are adapted to relate to at least one out of: energy efficiency rating, sustainable energy percentage and energy geographically origin, and kind of power used.

34. (canceled)

35. (canceled)

36. (canceled)
